(19) United States
(12) Patent Application Publication
(10) Pub. No.: US 2025/0053471 A1
(43) Pub. Date: Feb. 13, 2025

(54) STORAGE SYSTEMS INCLUDING HOST AND STORAGE DEVICES AND METHODS OF OPERATING THE SAME

(71) Applicant: SAMSUNG ELECTRONICS CO., LTD., Suwon-si (KR)

(72) Inventors: Kihyun Park, Suwon-si (KR); Inhae Kang, Suwon-si (KR); Hyunseok Kim, Suwon-si (KR)

(21) Appl. No.: 18/788,892

(22) Filed: Jul. 30, 2024

(30) Foreign Application Priority Data
Aug. 9, 2023 (KR) 10-2023-0103960
Dec. 5, 2023 (KR) 10-2023-0174931

(51) Int. Cl. G06F 11/07

(52) U.S. Cl. CPC G06F 11/0757; G06F 11/073

(57) ABSTRACT

Provided are a storage system including a host and a storage device and a method of operating the storage system. The method includes, when a response time of the storage device is greater than a threshold time, stopping, by the storage system, a previous mode and entering a recovery mode, when a state of a connection between the host device and the storage device is a link down state, resetting, by the storage system, the connection between the host device and the storage device, transmitting, by the host device, a recovery signal to the storage device, and performing, by the storage device, storage recovery.

### CROSS-REFERENCE TO RELATED APPLICATION

This application claims priority under 35 U.S.C. § 119 to Korean Patent Application Nos. 10-2023-0103960, filed on Aug. 9, 2023, and 10-2023-0174931, filed on Dec. 5, 2023, in the Korean Intellectual Property Office, the disclosures of which are incorporated by reference herein in their entirety.

### BACKGROUND

Semiconductor memories include volatile memory devices that lose data stored therein when power supply the volatile memory devices is interrupted (e.g., static random access memory (SRAM), dynamic RAM (DRAM), etc.) and non-volatile memory devices that retain data stored therein even when power supply thereto is interrupted (e.g., flash memory devices, phase change RAM (PRAM), magnetic RAM (MRAM), resistive RAM (RRAM), and ferroelectric RAM (FRAM)). A solid state drive (SSD), which includes non-volatile memory as a memory system, is used in many electronic devices.

### SUMMARY

Some implementations according to this disclosure provide a storage system including a host device that provides a recovery opportunity to a storage device and a method of operating the same.

According to some implementations, there is provided a method of operating a storage system, wherein the storage system includes a host device and a storage device including a plurality of non-volatile memories, the method including when a response time of the storage device is greater than a threshold time, stopping, by the storage system, a previous mode and entering a recovery mode, when a state of a connection between the host device and the storage device is a link down state, resetting, by the storage system, the connection between the host device and the storage device, transmitting, by the host device, a recovery signal to the storage device, and performing, by the storage device, storage recovery.

According to some implementations, there is provided a storage system including a host device, and a storage device including a plurality of non-volatile memories, wherein when a response time of the storage device is greater than a threshold time, the host device stops a previous mode and enters a recovery mode, and, when a state of a connection between the host device and the storage device is a link down state, the host device resets the connection between the host device and the storage device and transmits a recovery signal to the storage device, and the storage device performs storage recovery.

According to some implementations, there is provided a method of operating a host device, the method including when a response time of a storage device including a plurality of non-volatile memories is greater than a threshold time, stopping, by the host device, a previous mode and entering a recovery mode, when a state of a connection between the host device and the storage device is a link down state, resetting, by the host device, the connection between the host device and the storage device, and transmitting a recovery signal to perform storage recovery from the host device to the storage device.

### BRIEF DESCRIPTION OF THE DRAWINGS

Implementations will be more clearly understood from the following detailed description taken in conjunction with the accompanying drawings in which:

FIG. 1 is a block diagram showing a storage system according to some implementations;

FIG. 2 is a block diagram showing a storage system according to some implementations;

FIG. 3 is a flowchart of a method of operating a storage system, according to some implementations;

FIG. 4 is a flowchart of a method of operating a storage system, according to some implementations;

FIG. 5 is a flowchart of a method of operating a storage system, according to some implementations;

FIG. 6 is a block diagram showing a memory device according to some implementations;

FIG. 7 is a block diagram showing a system to which a storage system is applied;

FIG. 8 is a block diagram showing a data center to which a storage system is applied; and

FIG. 9 is a cross-sectional view of a bonding vertical NAND (BVNAND) structure applicable to a storage device, according to some implementations.

### DETAILED DESCRIPTION

A storage system may include a storage device and a host device, and the host device may immediately enter a system failure mode when a fault occurs in the storage device. Even when the storage device has internal recovery methods such as internal defect recovery, system stability problems may arise due to the absence of a communication method that provides opportunities for recovery with the host device. Some implementations according to this disclosure can provide improved system stability based on the described operations of host devices and storage devices.

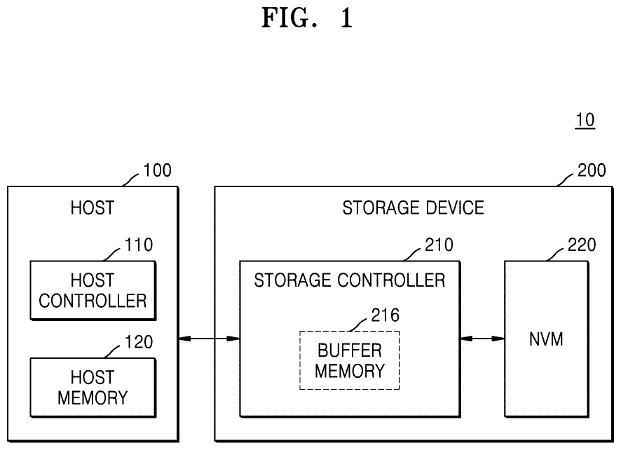

FIG. 1 is a block diagram showing a storage system according to some implementations.

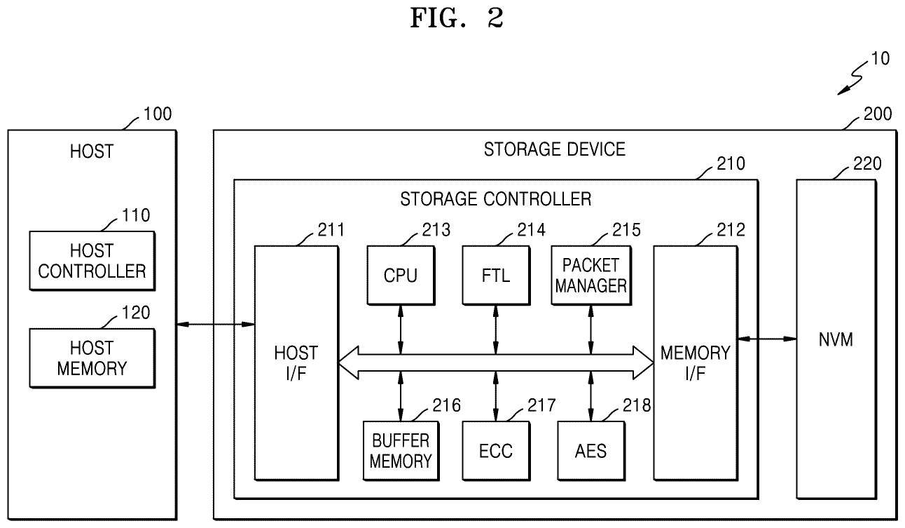

Referring to FIG. 1, a storage system 10 may include a host 100 and a storage device 200. The storage device 200 may include a storage controller 210 and a non-volatile memory (NVM) 220. The storage device 200 may include storage media for storing data according to requests from the host 100. Operations of the host 100 and the storage device 200 are described in detail below with reference to FIG. 2.

A host controller 110 may manage an operation of storing data (e.g., write data) of a buffer region in the NVM 220 or an operation of storing data (e.g., read data) of the NVM 220 in the buffer region.

A host memory 120 of the host 100 may function as a buffer memory for temporarily storing data to be transmitted to the storage device 200 or data transmitted from the storage device 200.

The storage controller 210 exists inside the storage device 200 and may perform a series of processes for storing data according to a request that the storage device 200 receives from the host 100. A buffer memory 216 may be a component provided in the storage controller 210 but may, in some implementations, be provided outside the storage controller 210 in the storage device 200.

When the NVM 220 of the storage device 200 includes a flash memory, the flash memory may include a 2D NAND memory array or a 3D (or vertical) NAND (VNAND) memory array. In various implementations, the storage device 200 may include various other types of non-volatile memories.

The host 100 and the storage device 200 may generate and transmit packets according to standard protocols employed thereby, respectively. For example, the host 100 and the storage device 200 may communicate with each other using the Non-Volatile Memory Express (NVMe) scheme and may communicate with each other through a bus based on the Peripheral Component Interconnect Express (PCIe) standard.

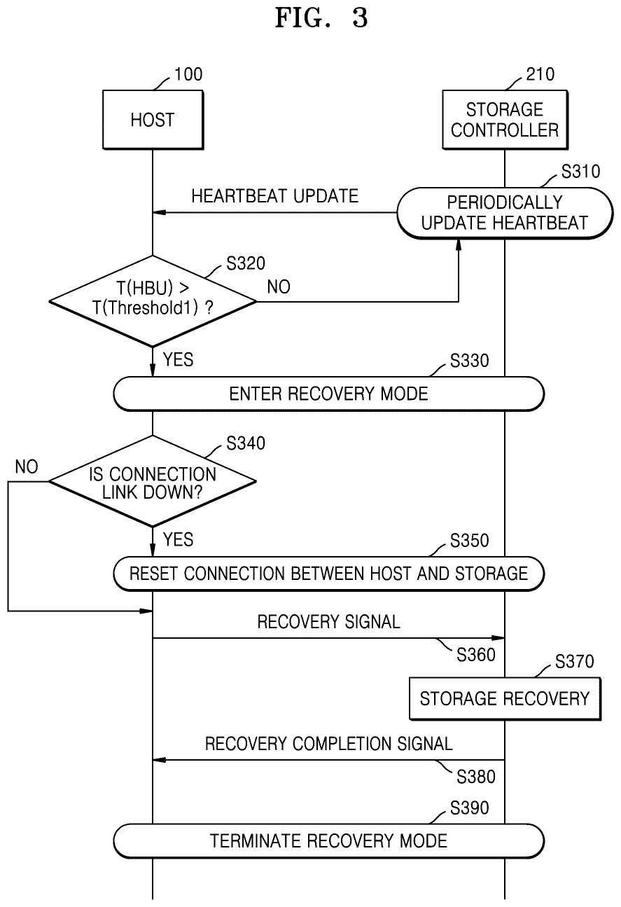

The host memory 120 and the buffer memory 216 may temporarily store packets in the process of generating and transmitting packets according to a standard protocol employed by the host 100 and the storage device 200. For example, during communication using the NVMe scheme, the host 100 and the storage device 200 may communicate by storing packets that comply with the NVMe scheme in the host memory 120 and the buffer memory 216. Also, the host 100 and the storage device 200 may be configured to communicate according to the PCIe standard and may communicate with each other by storing packets that comply with the PCIe standard in the host memory 120 and the buffer memory 216. For convenience, in the present specification, routes for communicating using the NVMe scheme may be collectively referred to as an NVMe channel, and routes for communicating using the PCIe standard may be collectively referred to as a PCIe channel. PCIe is a bus interface standard, and NVMe is a protocol that standardizes communication scheme standards. PCIe and NVMe are protocols/standards that can be applied simultaneously. In some implementations, unique packets may be stored in the host memory 120 and the buffer memory 216 during communications using respective protocols. Therefore, in some implementations, the NVMe channel and the PCIe channel may refer to communication schemes that utilize unique packets during communications using respective protocols. Transmission of recovery signals using the NVMe channel and PCIe channel is described in detail below with reference to FIGS. 3 to 5.

FIG. 2 is a block diagram showing a storage system according to some implementations.

Referring to FIG. 2, the storage system 10 may include the host 100 and the storage device 200. Also, the storage device 200 may include the storage controller 210 and the NVM 220.

Also, according to some implementations, the host 100 may include the host controller 110 and the host memory 120. The host memory 120 may function as a buffer memory for temporarily storing data to be transmitted to the storage device 200 or data transmitted from the storage device 200.

The storage device 200 may include storage media for storing data according to requests from the host 100. As an example, the storage device 200 may include at least one of an SSD, an embedded memory, and a removable external memory. When the storage device 200 is an SSD, the storage device 200 may be a device complying with the NVMe standard. When the storage device 200 is an embedded memory or an external memory, the storage device 200 may be a device complying with the universal flash storage (UFS) standard or the embedded multi-media card (cMMC) standard. The host 100 and the storage device 200 may generate and transmit packets according to standard protocols employed thereby, respectively.

When the NVM 220 of the storage device 200 includes a flash memory, the flash memory may include a 2D NAND memory array or a 3D (or vertical) NAND (VNAND) memory array. In various implementations, the storage device 200 may include various other types of non-volatile memories. For example, the storage device 200 may include magnetic RAM (MRAM), spin-transfer torque MRAM, conductive bridging RAM (CBRAM), ferroelectric RAM (FeRAM), phase RAM (PRAM), resistive RAM, and/or various other types of memory.

According to some implementations, the host controller 110 and the host memory 120 may be implemented as separate semiconductor chips. Alternatively, in some implementations, the host controller 110 and the host memory 120 may be integrated on the same semiconductor chip. According to some implementations, the host controller 110 may be any one of a plurality of modules included in an application processor, and the application processor may be implemented as a system-on-chip (SoC). Also, the host memory 120 may be an embedded memory provided in the application processor or a non-volatile memory or a memory module disposed outside the application processor.

The host controller 110 may manage an operation of storing data (e.g., write data) of the host memory 120 in the NVM 220 or an operation of storing data (e.g., read data) of the NVM 220 in the host memory 120.

The storage controller 210 may include a host interface 211, a memory interface 212, and a central processing unit (CPU) 213. Also, the storage controller 210 may further include a flash translation layer (FTL) 214, a packet manager 215, a buffer memory 216, an error correction code (ECC) engine 217, and an advanced encryption standard (AES) engine 218. The storage controller 210 may further include a working memory in which the FTL 214 is loaded. Operations of programming and reading data to and from a non-volatile memory may be controlled as the CPU 213 executes the FTL 214.

The host interface 211 may transmit and receive packets to and from the host 100. A packet transmitted from the host 100 to the host interface 211 may include a command or data to be programmed to the NVM 220, and a packet transmitted from the host interface 211 to the host 100 may include a response to the command or data read from the NVM 220. The memory interface 212 may transmit, to the NVM 220, data to be programmed to the NVM 220 or may receive data read from the NVM 220. The memory interface 212 may be implemented to comply with a standard protocol such as Toggle or Open NAND Flash Interface (ONFI).

The FTL 214 may perform various functions such as address mapping, wear-leveling, and garbage collection. The address mapping operation is an operation for translating a logical address received from the host 100 into a physical address used to actually store data in the NVM 220. The wear-leveling is a technique for preventing excessive degradation of a particular block by allowing blocks in the NVM 220 to be uniformly used and may be, for example, implemented through firmware technology for balancing erase counts of physical blocks. The garbage collection is a technique for securing usable capacity in the NVM 220 by copying valid data of an old block to a new block and then erasing the old block.

The packet manager 215 may generate packets according to a protocol of an interface negotiated with the host 100 or may parse a variety of information from packets received from the host 100. Also, the buffer memory 216 may temporarily store data to be programmed to the NVM 220 or data to be read from the NVM 220. The buffer memory 216 may be a component provided in the storage controller 210 or may, in some implementations, be provided outside the storage controller 210.

The ECC engine 217 may detect and correct an error on read data read from the NVM 220. For example, the ECC engine 217 may generate parity bits regarding write data to be written to the NVM 220, and such parity bits may be stored in the NVM 220 together with the write data. When data is read from the NVM 220, the ECC engine 217 may correct an error of read data using parity bits read from the NVM 220 together with the read data, and may output error-corrected read data.

The AES engine 218 may perform at least one of an encryption operation and a decryption operation for data input to the storage controller 210 using a symmetric-key algorithm.

FIG. 3 is a flowchart of a method of operating a storage system, according to some implementations.

Referring to FIG. 3, the host 100 and the storage controller 210 in the storage system 10 may be connected to each other to exchange data therebetween. The storage system 10 may operate by performing a plurality of operations S310 to S390. Although FIG. 3 shows a flowchart in which the host 100 and the storage controller 210 are connected to each other, the scope of this disclosure is not limited thereto. For example, the storage controller 210 may be a component included in the storage device 200, and, in some cases, the host 100 and the storage device 200 may perform the method shown in FIG. 3.

In operation S310, the storage controller 210 may periodically update a heartbeat to the host 100. A heartbeat is an information exchange signal that allows data to be shared at a certain period and may perform the function of notifying the normal operation of a system from one system to another. For example, the storage device 200 and the host 100 may be connected to each other and communicate as described above with reference to FIG. 1. The storage controller 210 may periodically transmit heartbeats to the host 100, and the host 100 may confirm that the storage device 200 and the host 100 are communicating normally by periodically receiving the heartbeats. For example, the heartbeat may be used as a signal to confirm that a system including two devices/systems (such as the host 100 and the storage controller 210) is operating normally and is capable of communicating normally.

In operation S320, the host 100 may determine whether a heartbeat update time (T (HBU)) is greater than a first threshold time. The first threshold time is a reference time for determining a case where the heartbeat update time is not updated within a certain time, and may be a value set in advance (predetermined). The heartbeat update time may refer to a time interval between heartbeats that are periodically updated from the storage controller 210 to the host 100, or since a last heartbeat from the storage controller 210 to the host 100. When the heartbeat update time is greater than the first threshold time, operation S330 may be performed, and, when the heartbeat update time is not greater than the first threshold time, operation S310 may be performed. For example, when the heartbeat update time is not greater than the first threshold time, the storage system 10 may continuously update heartbeats and operate normally. Hereinafter, a normal operating state is referred to as a “normal mode”.

In operation S330, the storage system 10 may enter a recovery mode. When it is determined in operation S320 that the heartbeat update time is greater than the first threshold time, there is a possibility that a problem may occur in communication or connection between the storage device 200 and the host 100. Therefore, in operation S330, the storage system 10 switches from the normal mode to the recovery mode, and a process for recovery of the storage device 200 may be performed as follows.

In operation S340, the host 100 may determine whether the connection between the host 100 and the storage device 200 is in a link down state. For example, the host 100 according to some implementations may determine whether a PCIe connection between the host 100 and the storage device 200 is down or “link down” (e.g., non-functional or having another error state). A problem with the connection between the host 100 and the storage device 200 may be a PCIe connection problem or an NVMe connection problem. The PCIe connection is the standard for a bus interface, and, when a problem occurs in the connection of terminals, it may be a link down state in which a problem occurs in the PCIe connection. The host 100 may determine whether the PCIe connection is down or “link down.”

In operation S350, based on the connection being down, the storage system 10 may reset the connection between the host 100 and the storage device 200. For example, when the PCIe connection is down, the method may proceed to operation S350, and, in operation S350, the storage system 10 may reset the PCIe connection. Accordingly, the storage system 10 may have an opportunity to overcome a communication fault occurring in the PCIe connection by resetting the PCIe connection.

In some implementations, the storage system 10 may reset the NVMe connection, e.g., in addition to or instead of resetting the PCIe connection. For example, the NVMe connection may be reset regardless of whether the PCIe connection is down, and, by resetting the NVMe connection, the storage system 10 may have an opportunity to overcome a communication fault occurring in the NVMe connection.

In operation S360, the host 100 may transmit a recovery signal to the storage controller 210. The recovery signal may be a signal that causes the storage device 200 to perform an internal recovery method, such as internal fault recovery. A recovery signal may be transmitted through communication channels interconnecting the host 100 with the storage device 200. For example, a recovery signal may be transmitted to the storage device 200 through a communication channel using the host memory 120 and the buffer memory 216 in the storage controller 210. The communication channel may be a PCIe channel or an NVMe channel, and descriptions identical to those given above with reference to FIG. 1 are omitted.

According to some implementations, the host 100 may transmit a recovery signal to the storage device 200 through a sideband channel connected between the host 100 and the storage device 200. A sideband channel may refer to a channel other than a main channel for transmitting data and signals needed to perform operations between the host 100 and the storage device 200. A sideband channel may be a channel including various protocols, such as System Management Bus (SMBus), Universal Asynchronous Receiver Transmitter (UART), Serial Peripheral Interface (SPI), and High-Speed Inter-Chip (HSIC). Accordingly, the host 100 may transmit a recovery signal to the storage device 200 in various ways, such as a sideband channel, a PCIe channel, or an NVMe channel.

In operation S370, the storage controller 210 may perform a storage recovery operation. The recovery operation may refer to various internal operations to correct errors, such as reset, reboot, rerun, and data recovery, performed to self-repair faults within the storage device 200. The storage device 200 may have an opportunity to overcome a communication fault that occurred between the host 100 and the storage device 200 by performing a storage recovery operation.

In operation S380, the storage controller 210 may transmit a recovery completion signal to the host 100. The recovery completion signal may be a signal to notify the host 100 that storage recovery has been completed. In operation S390, the storage system 10 may exit the recovery mode and switch back to the normal mode.

Accordingly, based on the process described with respect to FIG. 3, when a fault occurs in the connection between the host 100 and the storage device 200, the storage system 10 may not immediately enter a system error mode in which a system error is notified and an operation is stopped. Rather, the storage system 10 may prevent errors in the storage system 10 and improve the system stability of the storage system 10 by providing a recovery opportunity to the storage device 200.

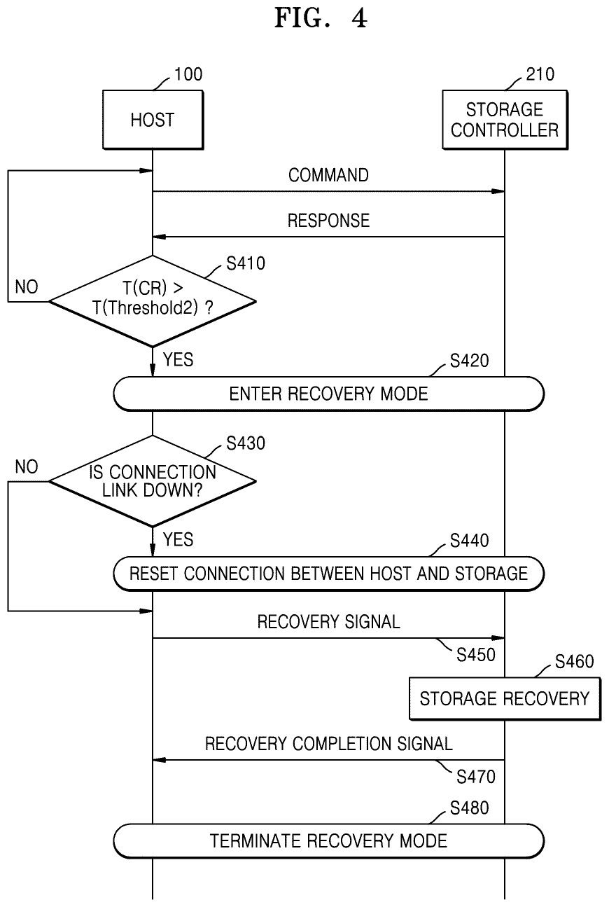

FIG. 4 is a flowchart of a method of operating a storage system, according to some implementations.

Referring to FIG. 4, the host 100 and the storage controller 210 in the storage system 10 may be connected to each other and exchange data therebetween. The storage system 10 may operate by performing a plurality of operations S410 to S480. Hereinafter, FIG. 4 is described with reference to FIG. 3, and descriptions identical to those given above with reference to FIG. 3 are omitted.

The method of operating the storage system 10 described with reference to FIG. 4 corresponds to a case of entering the recovery mode based on satisfaction of conditions, and operations S420 to S480 may correspond to operations S330 to S390 of FIG. 3. Description of operations S330 to S390 of FIG. 3 can be equally applied to operations S420 to S480.

In operation S410, the host 100 may determine whether a command response time T (CR) is greater than a second threshold time. The host 100 may transmit a command to the storage device 200, and the storage device 200 may perform an operation according to the command received from the host 100. For example, the storage device 200 may perform an operation according to a command from the host 100 and transmit data or signals corresponding to the command to the host 100. Such commands and responses corresponding to the commands may continuously occur while performing operations between the host 100 and the storage device 200. The command response time may refer to a period from a time point at which the host 100 transmits a command to the storage device 200 to a time point at which the host 100 receives data or signals corresponding to the command from the storage device 200, or a period from the time point at which the host 100 transmits the command to a current time point at which corresponding data or signals have not been received

The second threshold time is a reference time for determining a case where the command response time is not updated within a certain time, and may be a value set in advance (predetermined). When the command response time is greater than the second threshold time, operation S420 may be performed. When the command response time is not greater than the second threshold time, the host 100 and the storage device 200 of the storage system 10 may operate normally and continuously exchange commands and command responses.

According to the operation flowchart of the storage system 10 illustrated in FIG. 3, the storage system 10 may enter the recovery mode when the heartbeat update time is greater than the first threshold time. Also, according to the operation flowchart of the storage system 10 illustrated in FIG. 4, the storage system 10 may enter the recovery mode when the command response time is greater than the first threshold time. The conditions for entering the recovery mode illustrated in FIGS. 3 and 4 are only examples, and the storage system 10 may enter the recovery mode based on satisfaction of other conditions. For example, the storage system 10 according to some implementations may enter the recovery mode when the heartbeat update time is greater than the first threshold time or the command response time is greater than the second threshold time. Here, the first threshold time and the second threshold time are time values set in advance and may have different values from each other.

According to the process shown in FIG. 4, when a fault occurs in the connection between the host 100 and the storage device 200, the storage system 10 may not immediately enter a system error mode in which a system error is notified and an operation is stopped. The storage system 10 may prevent errors in the storage system 10 and improve the system stability of the storage system 10 by providing a recovery opportunity to the storage device 200.

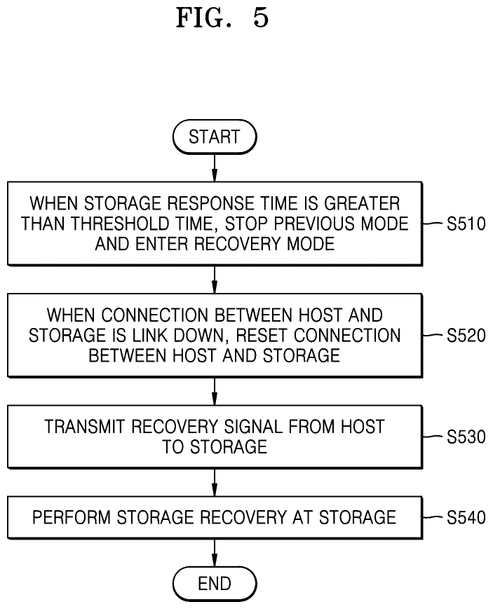

FIG. 5 is a flowchart of a method of operating a storage system, according to some implementations.

Referring to FIG. 5, the storage system 10 may operate by performing a plurality of operations S510 to S540. In describing FIG. 5, descriptions identical to those given above with reference to FIGS. 3 and 4 in relation to a method of operating the storage system 10 are omitted; the descriptions of FIGS. 3-4 can equally apply to operations of FIG. 5, except where noted otherwise.

In operation S510, when a storage response time is greater than a threshold time, the storage system 10 may stop a current mode and enter the recovery mode. The storage response time may be a heartbeat update time or a command response time. When the storage response time is a heartbeat update time, the threshold time may be a first threshold time, and, when the storage response time is a command response time, the threshold time may be a second threshold time.

In operation S520, when the connection state between the host 100 and the storage device 200 is a link-down state, the storage system 10 may reset the connection between the host 100 and the storage device 200. When a PCIe connection connecting the host 100 to the storage device 200 is down, the storage system 10 according to some implementations may reset the PCIe connection. The storage system 10 may check the state of connection between the host 100 and the storage device 200 and reset the connection, thereby providing an opportunity to overcome communication faults occurring in the connection. Also, in some implementations, the storage system 10 may have an opportunity to overcome a communication fault occurring in the PCIe connection by resetting the PCIe connection.

In operation S530, the storage system 10 may transmit a recovery signal from the host 100 to the storage device 200. The host 100 may transmit a recovery signal to the storage device 200 in various ways, such as a sideband channel, a PCIe channel, or an NVMe channel.

In operation S540, the storage system 10 may perform storage recovery on the storage device 200. The storage device 200 may have an opportunity to overcome a communication fault that occurred between the host 100 and the storage device 200 by performing a storage recovery operation.

Accordingly, when a fault occurs in the connection between the host 100 and the storage device 200, the storage system 10 may not immediately enter a system error mode in which a system error is notified and an operation is stopped. The storage system 10 may prevent errors in the storage system 10 and improve the system stability of the storage system 10 by providing a recovery opportunity to the storage device 200.

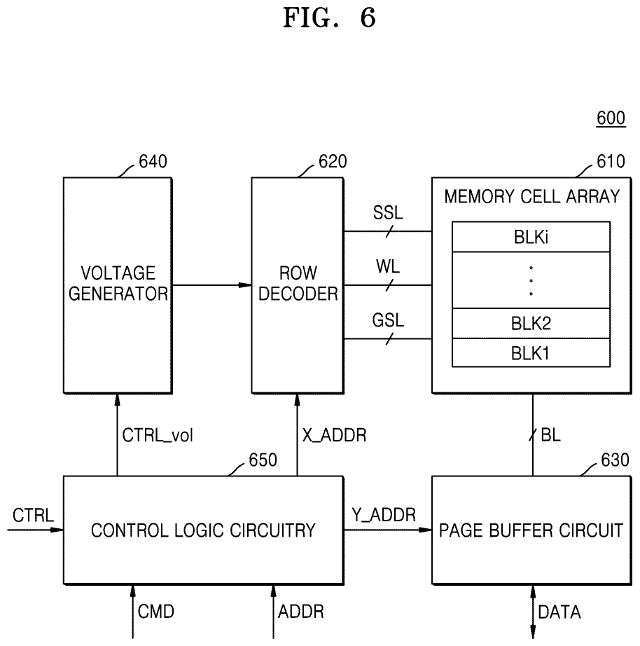

FIG. 6 is a block diagram showing a memory device according to some implementations.

As shown in FIG. 6, a memory device 600 may include a memory cell array 610, a row decoder 620, a page buffer circuit 630 (sometimes referred to as an input/output circuit), a voltage generator 640, and a control logic 650 (control logic circuitry).

The memory cell array 610 may include a plurality of memory cells and may be connected to word lines WL, string select lines SSL, ground select lines GSL, and bit lines BL. For example, the memory cell array 610 may be connected to the row decoder 620 through the word lines WL or select lines SSL and GSL and may be connected to the page buffer circuit 630 through bit lines BL.

The memory cell array 610 may include a plurality of memory blocks BLKI to BLKi. The plurality of memory blocks BLKI to BLKi may include at least one of a single-level cell (SLC) block including SLCs, a multi-level cell (MLC) block including MLCs, and a triple-level cell (TLC) block including TLCs. Some of a plurality of memory blocks included in the memory cell array 610 may be SLC blocks, and the other memory blocks may be MLC blocks or TLC blocks.

According to some implementations, each memory block may have a 3-dimensional structure (or a vertical structure). For example, each memory block may include a plurality of memory strings extending in a direction perpendicular to a substrate. However, the scope of this disclosure is not limited thereto, and in some implementations each memory block may have a 2-dimensional structure.

When an erase voltage is applied to the memory cell array 610, memory cells may enter an erase state. When a program voltage is applied to the memory cell array 610, the memory cells may enter a program state. In this case, each memory cell may be in an erase state E and at least one program state classified according to a threshold voltage Vth.

According to some implementations, when a memory cell is an SLC, the memory cell may have an erase state and a program state. According to some implementations, when a memory cell is an MLC, the memory cell may have an erase state and at least three program states.

The row decoder 620 may select some of the word lines WL in response to a row address X-ADDR. The row decoder 620 transfers a word line voltage to a word line. During a program operation, the row decoder 620 may apply a program voltage and a verify voltage to a selected word line WL and a program inhibit voltage to unselected word lines WL. The program inhibit voltage may be a high voltage. The high voltage may be a voltage having a higher level than that of a power voltage and generated by pumping the power voltage. The program voltage may be a high voltage having a level higher than the program inhibit voltage. During a read operation, the row decoder 620 may apply a read voltage to a selected word line WL and a read inhibit voltage to unselected word lines WL. Also, the row decoder 620 may select some of the string select lines SSL or some of the ground select lines GSL in response to the row address X-ADDR.

The page buffer circuit 630 may receive data from an external device (e.g., a controller) and store received data in the memory cell array 610. Also, the page buffer circuit 630 may read data from the memory cell array 610 and output read data to an external device or to the control logic 650. The page buffer circuit 630 may include page buffers corresponding to the bit lines BL. Also, the page buffer circuit 630 may include components such as a column select gate, a data buffer, a write driver, and a sense amplifier. The page buffers may be connected to the memory cell array 610 through the bit lines BL and may select some of the bit lines BL in response to a column address Y-ADDR received from the control logic 650. During a program operation, the page buffers may operate as a write driver and program data DATA to be stored in the memory cell array 610.

The voltage generator 640 may generate various types of voltages for performing a program operation, a read operation, and an erase operation on the memory cell array 610 based on a voltage control signal CTRL_vol. For example, the voltage generator 640 may generate a word line voltage, e.g., a program voltage (or a write voltage), a read voltage, a pass voltage (or a word line unselect voltage), or a verify voltage. The voltage generator 640 may generate a bit line voltage, e.g., a bit line forcing voltage, an inhibit voltage, etc. Also, the voltage generator 640 may further generate a string select line voltage and a ground select line voltage based on the voltage control signal CTRL_vol. In some implementations, the voltage generator 640 may generate a program pulse and a verify voltage of which levels are changed as the count of program loops increases based on the voltage control signal CTRL_vol. When a program loop is being performed, a programming method according to some implementations may be performed according to an incremental step pulse programming (ISPP) scheme, and the voltage generator 640 may generate a program pulse of which the level gradually increases from that of a previous program voltage.

The control logic 650 may output various control signals for writing data to the memory cell array 610 or reading data from the memory cell array 610, based on a command CMD, an address ADDR, and a control signal CTRL received from a controller. Therefore, the control logic 650 may overall control various operations within the memory device 600. Also, the control logic 650 may control the voltage generator 640 such that the voltage generator 640 generates at least one verify voltage and at least one program pulse in each program loop.

Various control signals output from the control logic 650 may be provided to the voltage generator 640, the row decoder 620, and the page buffer circuit 630. For example, the control logic 650 may provide the voltage control signal CTRL_vol to the voltage generator 640, provide the row address X-ADDR to the row decoder 620, and provide the column address Y-ADDR to the page buffer circuit 630. However, the scope of this disclosure is not limited thereto, and the control logic 650 may further provide other control signals to the voltage generator 640, the row decoder 620, and the page buffer circuit 630. Also, the control logic 650 may control all operations performed by the memory device 600 based on commands received from the controller, and the control logic 650 may perform operations performed by a program controller at the control logic 650. The program controller within the control logic 650 may be implemented as a hardware component or may be implemented as a firmware component.

The memory device 600 of FIG. 6 may correspond to the NVM 220 of FIGS. 1 and 2. For example, the NVM 220 described above may operate in the form and the structure of the memory device 600 described with reference to FIG. 6.

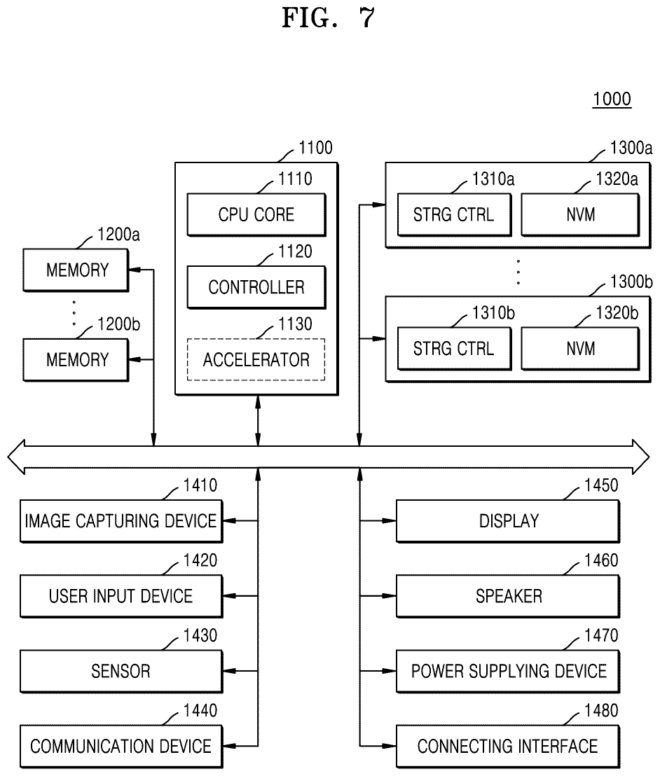

FIG. 7 is a block diagram showing a system to which a storage system according to some implementations is applied.

A system 1000 of FIG. 7 may be a mobile system such as a mobile phone, a smartphone, a tablet personal computer (PC), a wearable device, a healthcare device, or an Internet of Things (IoT) device. However, the system 1000 of FIG. 7 is not necessarily limited to a mobile system and may include a PC, a laptop computer, a server, a media player, or automobile device such as a navigation device.

Referring to FIG. 7, the system 1000 may include a main processor 1100, memories 1200a and 1200b, and storage devices 1300a and 1300b and may additionally include at least one of an image capturing device 1410, a user input device 1420, a sensor 1430, a communication device 1440, a display 1450, a speaker 1460, a power supplying device 1470, and a connecting interface 1480.

The main processor 1100 may control the overall operation of the system 1000, and, for example, the operations of other components constituting the system 1000. The main processor 1100 may be implemented by a general-purpose processor, a dedicated processor, or an application processor.

The main processor 1100 may include one or more CPU cores 1110 and may further include a controller 1120 for controlling the memories 1200a and 1200b and/or the storage devices 1300a and 1300b. According to some implementations, the main processor 1100 may further include an accelerator block 1130, which is a dedicated circuit for high-speed data operation such as artificial intelligence (AI) data operation. The accelerator block 1130 may include a graphics processing unit (GPU), a neural processing unit (NPU), and/or a data processing unit (DPU) and may also be implemented as a separate chip physically independent from the other components of the main processor 1100.

The memories 1200a and 1200b may be used as the main memory device of the system 1000 and may include volatile memories such as SRAMs and/or DRAMs. However, the scope of this disclosure is not limited thereto, and the memories 1200a and 1200b may also include non-volatile memories such as flash memories, PRAMs, and/or RRAMs. The memories 1200a and 1200b may be implemented in the same package as the main processor 1100.

The storage devices 1300a and 1300b may function as non-volatile storage devices that store data regardless of whether power is supplied thereto, and may have a relatively large storage capacity compared to the memories 1200a and 1200b. The storage devices 1300a and 1300b may include storage controllers 1310a and 1310b and non-volatile memories (NVMs) 1320a and 1320b that store data under control by the storage controllers 1310a and 1310b. The NVMs 1320a and 1320b may include a V-NAND flash memory having a 2-dimensional (2D) structure or a 3-dimensional (3D) structure but may include other types of non-volatile memories such as PRAM and/or RRAM.

The storage devices 1300a and 1300b may be included in the system 1000 but physically separated from the main processor 1100 or may be implemented in the same package as the main processor 1100. Also, the storage devices 1300a and 1300b may be solid state devices (SSDs) or memory cards, and thus the storage devices 1300a and 1300b may be detachably attached to the other components of the system 1000 through an interface such as a connection interface 1480 to be described below. The storage devices 1300a and 1300b may be devices to which standard protocols such as UFS, eMMC, or NVMe are applied, but are not necessarily limited thereto.

The image capturing device 1410 may capture a still image or a moving picture and may include a camera, a camcorder, and/or a webcam.

The user input device 1420 may receive various types of data input from a user of the system 1000 and may include a touch pad, a keypad, a keyboard, a mouse, and/or a microphone.

The sensor 1430 may sense various types of physical quantities that may be obtained from outside the system 1000 and transform sensed physical quantities into electrical signals. The sensor 1430 may include a temperature sensor, a pressure sensor, an illuminance sensor, a positional sensor, an acceleration sensor, a biosensor, and/or a gyroscope.

The communication device 1440 may transmit and receive signals to and from other devices outside the system 1000 according to various communication protocols. The communication device 1440 may include an antenna, a transceiver, and/or a modem.

The display 1450 and the speaker 1460 may function as output devices that output visual and auditory information to a user of the system 1000, respectively.

The power supplying device 1470 may appropriately convert power supplied from a battery embedded in the system 1000 and/or power supplied from an external power source and supply converted power to the components of the system 1000.

The connection interface 1480 may provide a connection between the system 1000 and an external device, which is capable of being connected to the system 1000 and exchanging data with the system 1000. The connection interface 1480 may be implemented as one of various interface protocols such as advanced technology attachment (ATA), serial ATA (ATA), external SATA (e-SATA), small computer small interface (SCSI), aerial attached SCSI (SAS), peripheral component interconnection (PCI), PCI express (PCIe), NVM express (NVMe), IEEE 1394, universal serial bus (USB), a secure digital (SD) card, a multi-media card (MMC), an eMMC, UFS, an embedded universal flash storage (eUFS), and a compact flash (CF) card interface.

The host 100 and the storage device 200 described above with reference to FIGS. 1 and 2 may correspond to the main processor 1100 and the storage devices 1300a and 1300b of FIG. 7, respectively. In some cases, the host 100 may correspond to a system including the main processor 1100 and the memories 1200a and 1200b. By performing the above-described methods, the system 1000 may provide recovery opportunities to the storage devices 1300a and 1300b to prevent errors in the storage system and improve system stability.

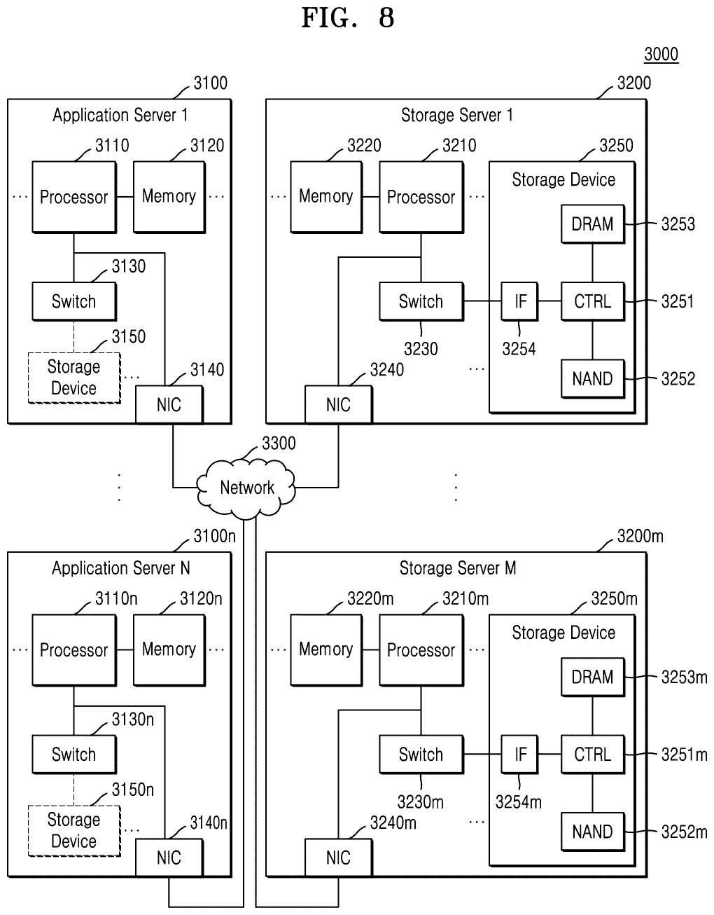

FIG. 8 is a block diagram showing a data center to which a storage system according to some implementations is applied.

Referring to FIG. 8, a data center 3000 is a facility that collects various types of data and provides services and may also be referred to as a data storage center. The data center 3000 may be a system for operating a search engine and a database and may also be a computing system used by a company such as a bank or a government agency. The data center 3000 may include application servers 3100 to 3100n and storage servers 3200 to 3200m. The number of application servers 3100 to 3100n and the number of storage servers 3200 to 3200m may vary according to different implementations, and the number of application servers 3100 to 3100n may be different from the number of storage servers 3200 to 3200m.

The application server 3100 or the storage server 3200 may include at least one of processors 3110 and 3210 and memories 3120 and 3220. In the case of the storage server 3200, a processor 3210 may control the overall operation of the storage server 3200 and access the memory 3220 to execute instructions and/or data loaded into the memory 3220. The memory 3220 may be double data rate synchronous DRAM (DDR SDRAM), high bandwidth memory (HBM), hybrid memory cube (HMC), dual in-line memory module (DIMM), optane DIMM, or non-volatile DIMM (NVMDIMM). The number of processors 3210 and the number of memories 3220 included in the storage server 3200 may vary in various implementations. In some implementations, the processor 3210 and the memory 3220 may provide a processor-memory pair. In some implementations, the number of processors 3210 may be different from the number of memories 3220. The processor 3210 may include a single core processor or a multiple core processor. The above description of the storage server 3200 and components thereof may be similarly applied to the application server 3100. According to some implementations, the application server 3100 may not include a storage device 3150. The storage server 3200 may include at least one storage device 3250. The number of storage devices 3250 included in the storage server 3200 may be variously selected according to different implementations.

The application servers 3100 to 3100n and the storage servers 3200 to 3200m may communicate with each other through the network 3300. The network 3300 may be implemented by using a fiber channel (FC) or Ethernet. Here, the FC may be a medium used for relatively high-speed data transmission, and an optical switch providing high performance/high availability may be used. The storage servers 3200 to 3200m may be provided as file storages, block storages, or object storages according to accessing methods of the network 3300.

According to some implementations, the network 3300 may be a storage-only network such as a storage area network (SAN). For example, the SAN may use an FC network and may be an FC-SAN implemented according to an FC Protocol (FCP). According to some implementations, the SAN may be an IP-SAN that uses a TCP/IP network and is implemented according to an iSCSI (SCSI over TCP/IP or Internet SCSI) protocol. According to some implementations t, the network 3300 may be a general network such as a TCP/IP network. For example, the network 3300 may be implemented according to protocols such as FC over Ethernet (FCOE), Network Attached Storage (NAS), and NVMe over Fabrics (NVMe-oF).

Hereinafter, descriptions mainly focus on the application server 3100 and the storage server 3200. Descriptions of the application server 3100 may be applied to other application servers 3100n, and descriptions of the storage server 3200 may also be applied to other storage servers 3200m.

The application server 3100 may store data requested to be stored by a user or a client in one of the storage servers 3200 to 3200m through the network 3300. Also, the application server 3100 may obtain data requested to be read by a user or a client from one of the storage servers 3200 to 3200m through the network 3300. For example, the application server 3100 may be implemented as a web server or a database management system (DBMS).

The application server 3100 may access a memory 3120n and/or a storage device 3150n included in another application server 3100n through the network 3300 and/or access the memories 3220 to 3220m and/or the storage devices 3250 to 3250m included in the storage servers 3200 to 3200m through the network 3300. Therefore, the application server 3100 may perform various operations on data stored in the application servers 3100 to 3100n and/or the storage servers 3200 to 3200m. For example, the application server 3100 may execute an instruction for moving or copying data between the application servers 3100 to 3100n and/or the storage servers 3200 to 3200m. At this time, data may be moved from the storage devices 3250 to 3250m of the storage servers 3200 to 3200m to the memories 3120 to 3120n of the application servers 3100 to 3100n, through the memories 3220 to 3220n of the storage servers 3200 to 3200m or directly. Data moving through the network 3300 may be data encrypted for security or privacy.

In the case of the storage server 3200, an interface 3254 may provide a physical connection between the processor 3210 and a controller 3251 and a physical connection between an NIC 3240 and the controller 3251. For example, the interface 3254 may be implemented as a direct attached storage in which a storage device 3250 is directly accessed through a dedicated cable. The interface 3254 may be implemented as, for example, one of various interface protocols such as advanced technology attachment (ATA), serial ATA (ATA), external SATA (e-SATA), small computer small interface (SCSI), aerial attached SCSI (SAS), peripheral component interconnection (PCI), PCI express (PCIe), NVM express (NVMe), IEEE 1394, universal serial bus (USB), a secure digital (SD) card, a multi-media card (MMC), an eMMC, UFS, an embedded universal flash storage (eUFS), and a compact flash (CF) card interface.

The storage server 3200 may further include a switch 3230 and the NIC 3240. The switch 3230 may selectively connect the processor 3210 to the storage device 3250 or selectively connect the NIC 3240 to the storage device 3250 under control by the processor 3210.

According to some implementations, the NIC 3240 may include a network interface card, a network adapter, etc. The NIC 3240 may be connected to the network 3300 through a wired interface, a wireless interface, a Bluetooth interface, an optical interface, etc. The NIC 3240 may include an internal memory, a DSP, a host bus interface, etc., and may be connected to the processor 3210 and/or the switch 3230 through the host bus interface. The host bus interface may be implemented as one of the examples of the interface 3254 described above. According to some implementations, the NIC 3240 may be integrated with at least one of the processor 3210, the switch 3230, and the storage device 3250.

In the storage servers 3200 to 3200m or the application servers 3100 to 3100n, processors may program or read data by transmitting commands to storage devices 3130 to 3130n and 3250 to 3250m or memories 3120 to 3120n and 3220 to 3220m. In this case, the data may be data that is error-corrected through an error correction code (ECC) engine. The data is data processed through data bus inversion (DBI) or data masking (DM) and may include cyclic redundancy code (CRC) information. The data may be encrypted for security or privacy.

The storage devices 3150 to 3150m and 3250 to 3250m may transmit control signals and commands/address signals to NAND flash memory devices 3252 to 3252m in response to a read command received from a processor. Therefore, in the case of reading out data from the NAND flash memory devices 3252 to 3252m, a read enable (RE) signal may be input as a data output control signal and may output data to a DQ bus. A data strobe (DQS) may be generated by using the RE signal. A command and an address signal may be latched in a page buffer according to a rising edge or a falling edge of a write enable (WE) signal.

The controller 3251 may control the overall operation of the storage device 3250. In some implementations, the controller 3251 may include SRAM. The controller 3251 may write data to a NAND flash 3252 in response to a write command or may read data from the NAND flash 3252 in response to a read command. For example, a write command and/or a read command may be provided from the processor 3210 in the storage server 3200, a processor 3210m in another storage server 3200m, or processors 3110 and 3110n in application servers 3100 and 3100n. DRAM 3253 may temporarily store (buffer) data to be written to the NAND flash 3252 or data read from the NAND flash 3252. Also, the DRAM 3253 may store meta-data. Here, meta-data is user data or data generated by the controller 3251 to manage the NAND flash 3252. The storage device 3250 may include a secure element (SE) for security or privacy.

The host 100 and the storage device 200 described above with reference to FIGS. 1 and 2 may correspond to the application servers 3100 to 3100n and the storage servers 3200 to 3200m of FIG. 8, respectively. By performing the above-described methods, the data center 3000 may provide recovery opportunities to the storage servers 3200 to 3200m to prevent errors in a storage system and improve system stability.

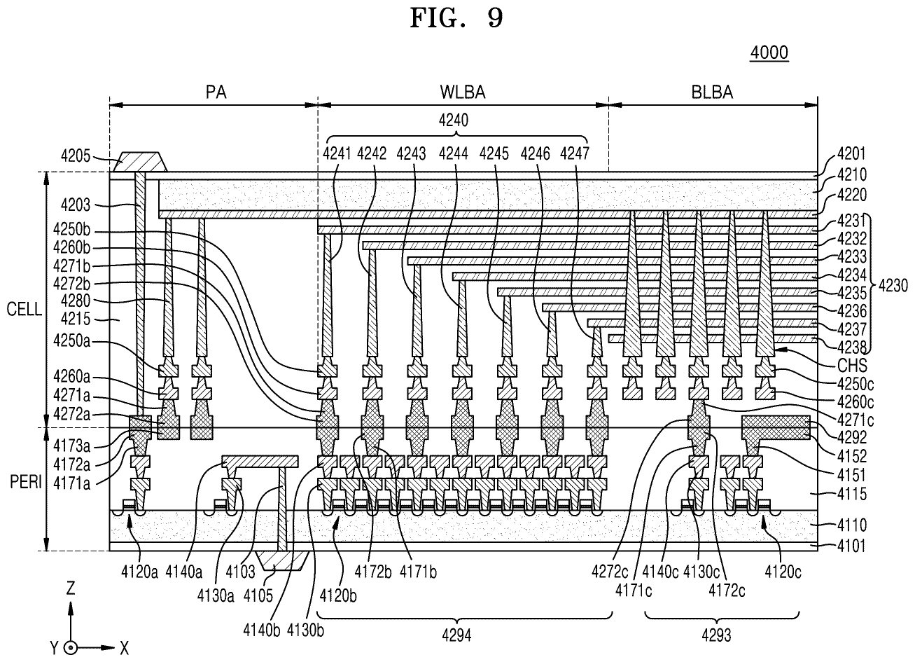

FIG. 9 is a cross-sectional view of a BVNAND structure applicable to a storage device, according to some implementations.

Referring to FIG. 9, a memory device 4000 may have a chip-to-chip (C2C) structure. The C2C structure may refer to a structure formed by fabricating an upper chip including a cell region CELL on a first wafer, fabricating a lower chip including a peripheral circuit region PERI on a second wafer that is different from the first wafer, and connecting the upper chip and the lower chip to each other through bonding. For example, the bonding may refer to an electric connection between a bonding metal formed on the uppermost metal layer of the upper chip and a bonding metal formed on the uppermost metal layer of the lower chip. For example, when the bonding metal includes copper (Cu), the bonding may be Cu—Cu bonding, and the bonding metal may also include aluminum or tungsten.

The peripheral circuit region PERI and the cell region CELL of the memory device 4000 may each include an external pad bonding area PA, a word line bonding area WLBA, and a bit line bonding area BLBA.

The peripheral circuit region PERI may include a first substrate 4110, an interlayer insulation layer 4115, a plurality of circuit elements 4120a, 4120b, and 4120c formed on the first substrate 4110, first metal layers 4130a, 4130b, and 4130c respectively connected to the circuit elements 4120a, 4120b, and 4120c, and second metal layers 4140a, 4140b, and 4140c respectively formed on the first metal layers 4130a, 4130b, and 4130c. In some implementations, the first metal layers 4130a, 4130b, and 4130c may include tungsten having relatively high resistance, whereas the second metal layers 4140a, 4140b, and 4140c may include copper having relatively low resistance.

Although only the first metal layers 4130a, 4130b, and 4130c and the second metal layers 4140a, 4140b, and 4140c are shown in FIG. 9, the scope of this disclosure is not limited thereto, and one or more metal layers may be further formed on the second metal layers 4140a, 4140b, and 4140c. At least some of the one or more metal layers formed on the second metal layers 4140a, 4140b, and 4140c may include a material, such as aluminum, having a lower resistance than copper constituting the second metal layers 4140a, 4140b, and 4140c.

An interlayer insulation layer 4115 is provided on the first substrate 4110 to cover the circuit elements 4120a, 4120b, and 4120c, the first metal layers 4130a, 4130b, and 4130c, and the second metal layers 4140a, 4140b, and 4140c and may include an insulation materials, such as a silicon oxide or a silicon nitride.

Lower bonding metals 4171b and 4172b may be formed on a second metal layer 4140b in the word line bonding area WLBA. In the word line bonding area WLBA, the lower bonding metals 4171b and 4172b in the peripheral circuit region PERI may be electrically connected to upper bonding metals 4271b and 4272b in the cell region CELL through bonding, wherein the lower bonding metals 4171b and 4172b and the upper bonding metals 4271b and 4272b may include aluminum, copper, or tungsten.

The cell region CELL may provide at least one memory block. The cell region CELL may include a second substrate 4210 and a common source line 4220. On the second substrate 4210, a plurality of word lines 4231 to 4238 and 4230 may be stacked in a direction perpendicular to the top surface of the second substrate 4210 (Z-axis direction). String select lines and a ground select line may be arranged on top and bottom of the word lines 4230, and the word lines 4230 may be arranged between the string select lines and the ground select line.

In the bit line bonding area BLBA, a channel structure CH may extend in a direction perpendicular to the top surface of the second substrate 4210 and penetrate through the word lines 4230, the string select lines, and the ground select line. The channel structure CH may include a data storage layer, a channel layer, and a buried insulation layer, and the channel layer may be electrically connected to a first metal layer 4250c and a second metal layer 4260c. For example, the first metal layer 4250c may be a bit line contact, and the second metal layer 4260c may be a bit line. In some implementations, the bit line 4260c may extend in a first direction parallel to the top surface of the second substrate 4210 (Y-axis direction).

In the example shown in FIG. 9, an area in which the channel structure CH and the bit line 4260c are arranged may be defined as the bit line bonding area BLBA. The bit line 4260c may be electrically connected to circuit elements 4120c, which provide a page buffer 4293 in the peripheral circuit region PERI, in the bit line bonding area BLBA. For example, the bit line 4260c is connected to upper bonding metals 4271c and 4272c in the peripheral circuit region PERI, and the upper bonding metals 4271c and 4272c may be connected to lower bonding metals 4171c and 4172c that are connected to the circuit elements 4120c of the page buffer 4293.

In the word line bonding area WLBA, the word lines 4230 may extend in a second direction parallel to the top surface of the second substrate 4210 (X-axis direction) and may be connected to a plurality of cell contact plugs 4241 to 4247 and 4240. The word lines 4230 and cell contact plugs 4240 may be connected to each other at pads provided by at least some of the word lines 4230 extending to different lengths along the second direction. A first metal layer 4250b and a second metal layer 4260b may be sequentially connected to the top of the cell contact plugs 4240 connected to the word lines 4230. In the word line bonding area WLBA, the cell contact plugs 4240 may be connected to the peripheral circuit region PERI through the upper bonding metals 4271b and 4272b in the cell region CELL and the lower bonding metals 4171b and 4172b in the peripheral circuit region PERI.

The cell contact plugs 4240 may be electrically connected to circuit elements 4120b that provide a row decoder 4294 in the peripheral circuit region PERI. According to some implementations, an operating voltage of the circuit elements 4120b providing the row decoder 4294 may be different from an operating voltage of the circuit elements 4120c providing the page buffer 4293. For example, the operating voltage of the circuit elements 4120c providing the page buffer 4293 may be greater than the operating voltage of the circuit elements 4120b providing the row decoder 4294.

A common source line contact plug 4280 may be provided in the external pad bonding area PA. The common source line contact plug 4280 include a conductive material such as a metal, a metal compound, or polysilicon and may be electrically connected to the common source line 4220. A first metal layer 4250a and a second metal layer 4260a may be sequentially stacked on the common source line contact plug 4280. For example, an area in which the common source line contact plug 4280, the first metal layer 4250a, and the second metal layer 4260a are arranged may be defined as the external pad bonding area PA.

Meanwhile, input/output pads 4105 and 4205 may be arranged in the external pad bonding area PA. Referring to FIG. 9, a lower insulation layer 4101 covering the bottom surface of the first substrate 4110 may be formed below the first substrate 4110, and a first input/output pad 4105 may be formed on the lower insulation layer 4101. The first input/output pad 4105 is connected to at least one of the circuit elements 4120a, 4120b, and 4120c arranged in the peripheral circuit region PERI through a first input/output contact plug 4103 and may be separated from the first substrate 4110 by the lower insulation layer 4101. Also, a side insulation layer may be provided between the first input/output contact plug 4103 and the first substrate 4110 to electrically separate the first input/output contact plug 4103 from the first substrate 4110.

Referring to FIG. 9, an upper insulation layer 4201 covering the top surface of the second substrate 4210 may be formed on the second substrate 4210, and a second input/output pad 4205 may be provided on the upper insulation layer 4201. The second input/output pad 4205 may be connected to at least one of the circuit elements 4120a, 4120b, and 4120c arranged in the peripheral circuit region PERI through a second input/output contact plug 4203.

According to some implementations, the second substrate 4210 and the common source line 4220 may not be arranged in an area where the second input/output contact plug 4203 is provided. Also, the second input/output pad 4205 may not overlap the word lines 4230 in the third direction (Z-axis direction). Referring to FIG. 9, the second input/output contact plug 4203 is separated from the second substrate 4210 in a direction parallel to the top surface of the second substrate 4210 and may penetrate through an interlayer insulation layer 4215 in the cell region CELL and be connected to the second input/output pad 4205.

According to some implementations, the first input/output pad 4105 and the second input/output pad 4205 may be selectively formed. For example, the memory device 4000 may include only the first input/output pad 4105 provided on the first substrate 4110 or only the second input/output pad 4205 provided on the second substrate 4210. The memory device 4000 may include both the first input/output pad 4105 and the second input/output pad 4205.

In each of the external pad bonding area PA and the bit line bonding area BLBA included in each of the cell region CELL and the peripheral circuit region PERI, a metal pattern of an uppermost metal layer may exist as a dummy pattern or the uppermost metal layer may be omitted.

In the memory device 4000, in the external pad bonding area PA, in correspondence to an upper metal pattern 4272a formed on the uppermost metal layer in the cell region CELL, a lower metal pattern 4176a having the same shape as the upper metal pattern 4272a in the cell region CELL may be formed on the uppermost metal layer in the peripheral circuit region PERI. The lower metal pattern 4176a formed on the uppermost metal layer in the peripheral circuit region PERI may not be connected to a separate contact in the peripheral circuit region PERI. Similarly, in the external pad bonding area PA, in correspondence to a lower metal pattern formed on the uppermost metal layer in the peripheral circuit region PERI, an upper metal pattern having the same shape as the lower metal pattern in the peripheral circuit region PERI may be formed on the uppermost metal layer in the cell region CELL.

The lower bonding metals 4171b and 4172b may be formed on the second metal layer 4140b in the word line bonding area WLBA. In the word line bonding area WLBA, the lower bonding metals 4171b and 4172b in the peripheral circuit region PERI may be electrically connected upper bonding metals 4271b and 4272b in the cell region CELL through bonding.

Also, in the bit line bonding area BLBA, in correspondence to a lower metal pattern 4152 formed on the uppermost metal layer in the peripheral circuit region PERI, an upper metal pattern 4292 having the same shape as the lower metal pattern 4152 may be formed on the uppermost metal layer in the cell region CELL. A contact may not be formed on the upper metal pattern 4292 formed on the uppermost metal layer in the cell region CELL.

The memory device 4000 of FIG. 9 may correspond to the NVM 220 of FIGS. 1 and 2. For example, the NVM 220 described above may operate in the form and the structure of the memory device 4000 described with reference to FIG. 9.

While various examples have been particularly shown and described, it will be understood that various changes in form and details may be made therein without departing from the spirit and scope of the following claims.

What is claimed is:

1. An operation method of a storage system, wherein the storage system comprises a host device and a storage device including a plurality of non-volatile memories, the method comprising:
based on a response time of the storage device being greater than a threshold time, terminating a previous mode of the storage device and setting the storage system to a recovery mode;
based on a state of a connection between the host device and the storage device being a link down state, resetting, by the storage system, the connection between the host device and the storage device;
transmitting, by the host device, a recovery signal to the storage device; and
performing, by the storage device, storage recovery based on receiving the recovery signal.

2. The method of claim 1, wherein the response time of the storage device is a heartbeat update time of the storage device.

3. The method of claim 1, wherein the response time of the storage device is a response time of the storage device to a command signal from the host device.

4. The method of claim 1, wherein the host device comprises a host memory,
wherein the storage device comprises a storage controller including a buffer memory, and,
wherein the recovery signal is transmitted from the host device to the storage device through a channel for data storage and transmission between the host memory and the buffer memory.

5. The method of claim 4, wherein the channel comprises a peripheral component interconnect express (PCIe) channel or a non-volatile memory express (NVMe) channel.

6. The method of claim 1, wherein setting the storage system to the recovery mode comprises:
determining whether a heartbeat update time of the storage device is greater than a first threshold time;
determining whether a response time of the storage device with respect to a command signal of the host device is greater than a second threshold time, wherein the first threshold time is different from the second threshold time; and
setting the storage system to the recovery mode based on the heartbeat update time being greater than the first threshold time or the response time being greater than the second threshold time.

7. The method of claim 1, wherein the connection comprises a peripheral component interconnect express (PCIe) connection,
wherein resetting the connection comprises resetting the PCIe connection, and
wherein the method further comprises resetting a non-volatile memory express (NVMe) connection between the storage device and the host device.

8. The method of claim 1, wherein the recovery signal is transmitted from the host device to the storage device through a side band channel between the storage device and the host device.

9. A storage system comprising:
a host device; and
a storage device comprising a plurality of non-volatile memories,
wherein the storage system is configured to stop a previous mode and enter a recovery mode based on a response time of the storage device being greater than a threshold time,
wherein, based on a state of a connection between the host device and the storage device being a link down state, the host device is configured to
resets the connection between the host device and the storage device, and
transmit a recovery signal to the storage device, and
wherein the storage device is configured to perform storage recovery based on receiving the recovery signal.

10. The storage system of claim 9, wherein the response time of the storage device is a heartbeat update time of the storage device.

11. The storage system of claim 9, wherein the response time of the storage device is a response time of the storage device to a command signal from the host device.

12. The storage system of claim 9, wherein the host device comprises a host memory,
wherein the storage device comprises a storage controller including a buffer memory, and,
wherein the recovery signal is transmitted from the host device to the storage device through a channel for data storage and transmission between the host memory and the buffer memory.

13. The storage system of claim 12, wherein the channel is a peripheral component interconnect express (PCIe) channel or a non-volatile memory express (NVMe) channel.

14. The storage system of claim 9, wherein the host device is configured to:
determine whether a heartbeat update time of the storage device is greater than a first threshold time;
determine whether a response time of the storage device with respect to a command signal of the host device is greater than a second threshold time, wherein the first threshold time is different from the second threshold time; and
set the storage system to the recovery mode based on the heartbeat update time being greater than the first threshold time or the response time being greater than the second threshold time.

15. The storage system of claim 9, wherein the connection is a peripheral component interconnect express (PCIe) connection,
wherein resetting the connection comprises resetting the pcie connection, and
wherein the host device is configured to reset a non-volatile memory express (NVMe) connection between the storage device and the host device.

16. The storage system of claim 9, wherein the recovery signal is transmitted from the host device to the storage device through a side band channel between the storage device and the host device.

17. An operation method of a host device, the method comprising:
based on a response time of a storage device being greater than a threshold time, stopping, by the host device, a previous mode of a storage system and setting the storage system to a recovery mode, wherein the storage system comprises the host device and the storage device, and wherein the storage device comprises a plurality of non-volatile memories;
based on a state of a connection between the host device and the storage device being a link down state, resetting, by the host device, the connection between the host device and the storage device; and
transmitting a recovery signal from the host device to the storage device, the recovery signal configured to cause the storage device to perform storage recovery.

18. The method of claim 17, wherein the response time of the storage device is a heartbeat update time of the storage device.

19. The method of claim 17, wherein the response time of the storage device is a response time of the storage device to a command signal from the host device.

20. The method of claim 17, wherein the host device comprises a host memory,
wherein the storage device comprises a storage controller including a buffer memory, and,
wherein the recovery signal is transmitted from the host device to the storage device through a channel for data storage and transmission between the host memory and the buffer memory.
